(19) United States
(12) Patent Application Publication
(10) Pub. No.: US 2026/0148153 A1
(43) Pub. Date: May 28, 2026

(54) WORKFORCE ASSESSMENT AND SCHEDULING SYSTEMS AND METHODS

(71) Applicant: Government of the United States as represented by the Secretary of the Air Force, Wright-Patterson AFB, OH (US)

(72) Inventor: Jacob Ehrlich, Bossier City, LA (US)

(21) Appl. No.: 18/960,250

(22) Filed: Nov. 26, 2024

(51) Int. Cl. G06Q 10/0631; G06Q 10/04

(52) U.S. Cl. CPC G06Q 10/063112; G06Q 10/04

(57) ABSTRACT

A computer system and computer implemented method. The method includes identifying a plurality of operational readiness data and a plurality of policy data for a workforce; filtering the plurality of operational readiness data and the plurality of policy data to define a ready workforce; providing a first user interface to a manager; providing a second user interface to a worker; and detecting a selection of a date range for scheduling the ready workforce. Further, the method optionally includes receiving at least one priority constraint from the manager; receiving at least one scheduling preferences from a worker. The method includes calculating, by applying an iterative computer model, a work schedule for the ready workforce during the date range and publishing the work schedule.

### GOVERNMENT INTEREST

The invention described herein may be manufactured and used by or for the Government of the United States for all government purposes without the payment of any royalty.

### FIELD OF THE INVENTION

The embodiments herein relate to technical improvements for assessing, reporting, and managing personnel availability and scheduling.

### BACKGROUND

Effective scheduling of a complex workforce requires systems and methods that go beyond what can be accomplished manually. The shear quantity, location, and type of information required to effectively render timely access to information exceeds the capabilities of manual processes. Further, the scale of the problem requires technological innovations that exceed those employed in current capabilities.

A continuing, unaddressed need exists for systems and methods to achieve effective, timely scheduling of a workforce.

### BRIEF DESCRIPTION OF THE DRAWINGS

The embodiments herein will be better understood from the following detailed description of the drawings, in which:

FIG. 1 is a diagram of a representative system of the present disclosure;

FIG. 2 is a flow diagram of a representative method of the present disclosure;

FIG. 3 is a diagram of a representative computer system of the present disclosure.

### DETAILED DESCRIPTION

Embodiments of the disclosed development, its various features, and the advantageous details thereof, are explained more fully concerning the non-limiting embodiments that are illustrated in the accompanying drawings and detailed in the following description. Descriptions of well-known components and processing techniques are omitted to not unnecessarily obscure what is being disclosed. Examples may be provided, and when so provided are intended merely to facilitate an understanding of how the invention may be practiced and to further enable those of skill in the art to practice its various embodiments. Accordingly, examples should not be construed as limiting the scope of what is disclosed and otherwise claimed.

The workforce assessment and scheduling systems and methods disclosed herein provide for dynamic, timely, effective, accessible and actionable information related to workforce scheduling. The examples described relate primarily to a military workforce in which personnel and assets may be distributed geographically to an extent that makes manual operation of similar systems and methods infeasible. However, the methods and systems described herein can be utilized in non-military applications, including civil, commercial, and private companies and organizations.

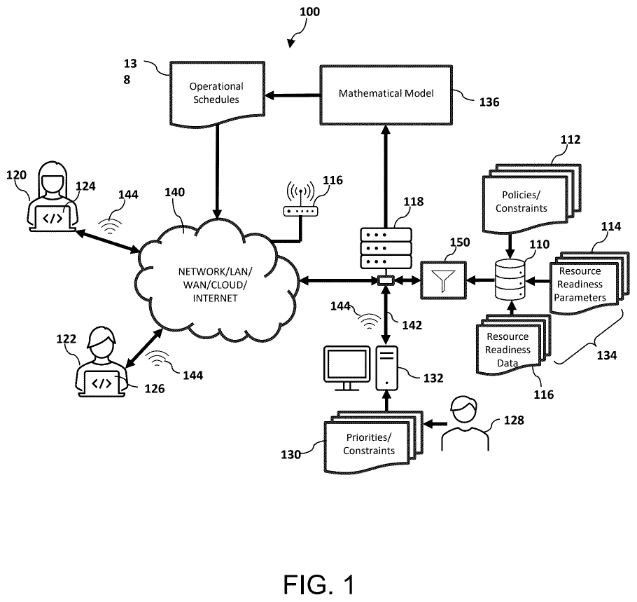

Referring to FIG. 1 there is shown a schematic diagram of a system 100 for workforce scheduling. The system can be employed for scheduling a private workforce or a public workforce. In one embodiment, the system 100 can be utilized for scheduling military resources and personnel. In an embodiment, the system 100 can be utilized to schedule alerts, often called “alert constructs” for military operations for which scheduling impacts public safety and military readiness. For example, missileers must be posted at United States Air Force missile alert facilities with 24/7 operational readiness and alert crew manning of launch control centers. Making, keeping, and executing on dynamic, optimal scheduling requires innovative uses of resources, as real-time, optimal scheduling requirements exceed the capabilities of timely manual scheduling.

The system 100 operates on computers, servers, and networks and utilizes application programming interfaces (APIs) and user interfaces to iteratively receive, process, and display data in real time. The system can comprise a non-transitory computer-readable medium with instructions encoded thereon. The data can include constraints and weighting factors that can be considered simultaneously in the iterative process, to achieve what was previously impossible by manual means: the dynamic vs static, and optimal vs possible or feasible, allocation of resources in changing real time.

The system includes memory 110, which can be centralized or distributed. In an embodiment memory 110 includes database storage of information from database sources, such as policy data 112 relating to scheduling policies, operational readiness data 134, such as resource readiness parameters 114, and/or resource readiness data 116 relating to a potentially ready workforce. The database sources can be referred to as authoritative database sources comprising authoritative data to distinguish data suitable for optimal scheduling from unrelated, irrelevant, outdated, or corrupted data. Further, data sources can be obtained by input from personnel, including those being scheduled, referred to as “workers” and those managing the scheduling, referred to herein as “managers”. For example, in FIG. 1 two workers are shown, a first worker 120 and a second worker 122, each of them interfacing with the system 100 via user interfaces, such as a first computing device 122 and a second computing device 124, respectively. Further, one or more managers 128 can set and input priorities 130 into the server 118 via a user interface, such as computer 132. The priorities can be workforce management priorities relating to customized or modified schedules, time off requests, workforce personnel compositions, and the like. In an embodiment, the workers can be missileers and the manager can be a commanding officer, such as a squadron commander.

The policies 112 can include legal and/or organizational requirements, such as numbers and categories of workers to be scheduled. For example, a policy may dictate that in an environment a worker of a specified level or rank be present at all times. A policy may also dictate required limitations for workers, such as limitations of work hours per day or work days per period. For example, it may be that missileers on alert be off for a certain period before the next alert. The policies can dictate constraints including hard constraints and/or soft constraints, as discussed below.

Resource readiness parameters 114 can be stored in database 110 for processing by the executable instructions of the server 118. Resource readiness parameters 114 can include, for each worker available for scheduling, personnel duties, roles, qualifications, availability, and personal schedule preferences. The database of resource readiness parameters 114 can be populated by data drawn from personnel records, training records, qualification certifications, and from workers themselves, such as worker 120 entering in schedule preferences via the computer 124.

Resource readiness data 116 can be stored in database 110 for processing by the executable instructions of the server 118. Resource readiness data 116 can include current status of training and qualifications, maintenance, supply and logistics, personnel and work experience, medical readiness, travel, and availability.

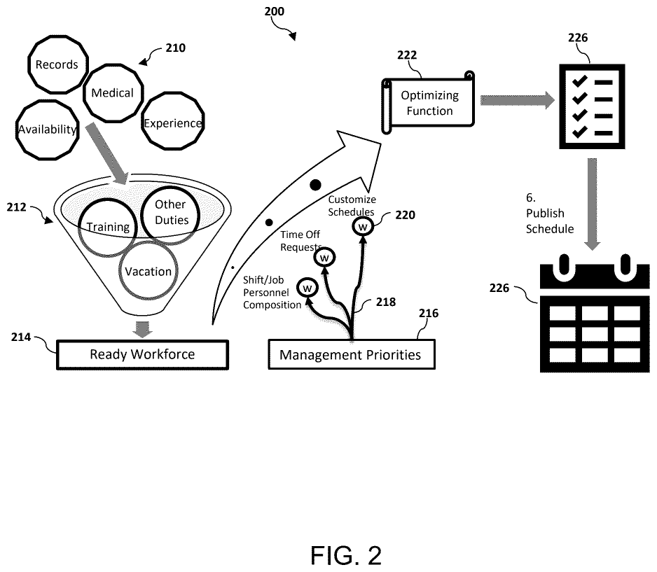

Data from all the various data sources can be filtered at filter component 150 according to such factors as the desired schedule length based on personnel readiness to provide for a filtered live status of the workforce. The filtering component 150 can be a filtering module of a central processing unit with memory and executable instructions to segregate and modify the data from the data sources by factors relevant to defining a ready workforce, such as desired schedule length, time off, e.g., vacation/leave requests, other duties that might interfere with scheduling, and training that might interfere with or otherwise impact optimal scheduling. As discussed more fully below in view of FIG. 2 and a method of operation, the filtering component 150 facilitates identifying a real-time ready workforce.

The filtered, ready work force can be optionally further dynamically modified by schedule parameters, including any instructions or factors related to the priorities of managers 128, such as managers of companies or commanders of a military unit. Such parameters can include deliberate shift pairing information, for example, to ensure certain pairings of workers are included or avoided. For example, it may be a workplace requirement that at least one each of a category, such as level or rank, be scheduled together. Further, schedule parameters can include pre-defined manual day requirements, mandatory workday patterns, necessary worker/crew rest, required currency training, defining back-up requirements, and prioritization of time-off requests. The database of resource readiness data 116 can be populated by data drawn from personnel records, training records, qualification certifications, and from workers themselves, such as worker 120 entering a time-off request via the computer 124.

Scheduling can be optimally determined by considering hard and soft constraints. Hard constraints are mission requirements specified by policy and/or situational context. In the example of formulating optimal missileer alert schedules, hard constraints can include, for example, requiring both a crew commander and deputy crew commander assigned to each launch control center every day, requiring crews to be properly qualified and ready, for relevant workers, requiring a travel day and the associated number of off days depending on the number of consecutive days on alert pulled in a sequence, and the like. In an embodiment, all mission requirements constraints must be met to produce an optimal schedule. Soft constraints can be violated to produce an optimal schedule. Soft constraint can be violated by introducing goal decision variables that behave like “slack/surplus” variables in traditional linear programming. Examples of soft constraints include time off requests. The generation of an optimal schedule may not allow for all requested days off to be honored, especially around major holidays. The necessity of producing an operationally optimal schedule requires some desired constraints to be violated.

The executable instructions of the server 118 include instructions to process the filtered and/or weighted data in the mathematical model 136 to produce the operational schedule(s) 138. The objective function of the mathematical model 136 can be processed in a scheduling module of the non-transitory computer-readable medium with instructions encoded thereon. One or more processors can be configured to, when executing the instructions, consider a weighted sum of all the goal decision variables, including the weights dictated by manager priorities/constraints 130. Soft and hard constraints can be quantified and/or weighted and can be included with resource readiness parameters 114 and resource readiness data 116 in an mathematical model 136 for optimal scheduling. The technical solution of the mathematical model can be formulated as a mathematical goal program where hard constraints represent mandatory requirements, policies, etc. that cannot be violated, and soft constraints incorporate the use of goals that allow constraints to be violated in order to produce a feasible and/or optimal schedule. Because goals can be added together and weighted according to established priorities, potentially conflicting schedule factors can be appropriately addressed in the mathematical model. In an embodiment, the mathematical model 136 includes sets of equations in a mixed integer goal program formulation coded in Python and solved using the PuLP package in Python.

In an embodiment, operational schedules can be prepared via a JavaScript interface for viewing by workers 120, 122 via the user interfaces of their computers 124, 126, respectively. In general, operational schedules can be disseminated as desired, for example to workers and managers, and/or other workforce components. In an embodiment, a scheduler can generate and view operational schedules and can choose to disseminate operational schedules in a full or limited manner. In an embodiment, the manager 128 is the scheduler, and can have complete visibility to operational schedules, as well as set parameters for the dissemination of operational schedules.

Referring now to FIG. 2, there is shown a representative flow diagram for a method 200 for optimal scheduling. Data 210 from authoritative data sources, including from policies 112, readiness parameters 114, and resource readiness data 116 are filtered for readiness at 212. As indicated in FIG. 2, data can include records data, medical data, experience data, availability data, and other data determined to relate to the current, real-time status of a potential workforce.

Filtering for readiness 212 includes modifying the current, real-time status of a potential workforce to determine a ready workforce 214. Filtering can take into account such factors as desired schedule length, vacation/leave requests, life events that affect availability, other duties that might interfere with scheduling, and training that might interfere with or otherwise impact optimal scheduling.

Once a ready workforce 214 of personnel is identified by filtering the authoritative data sources, further schedule parameters can be optionally configured at 218 by, for example, inputs from a manager 128 who applies priorities or constraints to scheduling. Constraints can include, for example, desired or required shift/job personnel composition, time off requests, and customized schedules. Further, weighting factors 220 can be assigned to one or more of the constraints. Weighting factors 220 can, influence scheduling in the event of competing priorities. Setting and weighting priorities can help delineate between feasible schedules and optimal schedules customized to each organization.

Once data, including optional priorities and parameters from management or optional preferences from workers, are set for the ready workforce 214, executable instructions in the processor of the server 118 perform an optimizing function 222 of the mathematical model 136 that dynamically constructs in real-time the operational schedule(s) 138 at 226. The schedule(s) 138 produced at method step 226 can then be published at 226 for limited or full dissemination to the workforce.

In general, for systems disclosed herein, the memory 110 can be in data communication with a server 118 that can be a computer with a central processing unit including executable instructions to gather, organize, formulate, and/or otherwise operate on inputs from data sources. The server 110 can serve as a central repository of data and formulations associated with the systems and methods herein and is described in more detail below.

Referring again to FIG. 1, the system 100 components can be operationally connected in wired or wireless configurations, including being hardwired 142 or connected via Wi-Fi, Bluetooth, or other wireless connection 144 to other components, including via network connections 140. The network connections 140 can include any of known wired or wireless communication technology, including wide area network(s) (WAN), local area network(s) (LAN), Internet, cloud computing, or other networked, distributed computing.

The system can be accessed by personnel, including those being scheduled and those managing the scheduling. For example, a first personnel member 120 and second personnel member 122, can each access the system 100 via a first computing device 124 and a second computing device 126, respectively, via a suitable user interface. The first and second computing devices are representative of a plurality of personnel computing devices, each of which can be a wired or wirelessly connected computer, tablet, phone, or other fixed or portable device. The personnel members 120 and 122 can enter and/or access personal information, work related constraints, life change information, scheduling information, and other data, including changing or modifying data.

The system and method described enable an iterative mathematical model 136 to output operational schedules 138 that reflect current and changing data and parameters, and can be accessed by personnel, including workers 120 and 122 or managers 128. Further, the live status feature provided by components such as the filtering function enable schedulers to manage role-based, dynamic and complex interdependencies in real time to produce optimal scheduling.

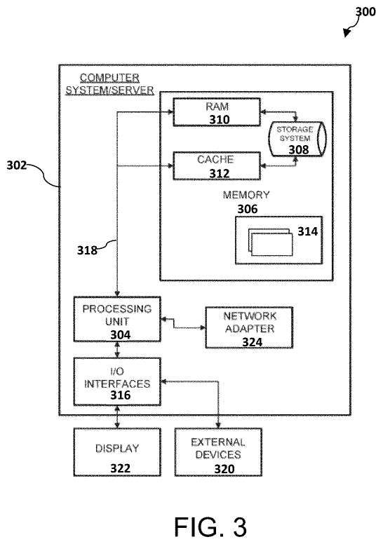

Referring now to FIG. 3, there is shown a schematic representation of a representative computing architecture 300 for use in the system 100 for performing the method 200 of the disclosure. The computing architecture 300 can describe any of the computer components described in the system 100 and used for the method 200. “Computer component” as used herein refers broadly to system 100 elements utilizing memory and processors to communicate with other components of the system 100, such as computing devices 124, 126, 132 and server 118. Computer components include the hardware, software, communications, and storage, including portions at a user location, portions at server/peer locations providing content and processing services, potentially including the entire Internet or any similar network to the extent that those elements are usable with the system and the resources that may be accessible to it.

FIG. 3 is a block diagram illustrating a computing architecture 300 configured to implement one or more aspects of the system and method described herein. The computing architecture 300 can comprise a computing system that includes a processing subsystem 302 having one or more processor(s) 304 and a system memory 306 communicating via an interconnection path that may include a memory storage 308. RAM 310 and a cache 312 can be coupled to memory storage 308 and may be a separate component within memory storage 308, part of a chipset component 314 or may be integrated within the one or more processor(s) 304. The memory storage 308 couples with the processor(s) 304 and I/O interfaces 316 via a communication link 318. The I/O interfaces 316 can enable the computing system 302 to receive input from one or more external devices 320. Additionally, the I/O interfaces 316 can enable a display 322 controlled by a display controller, which may be included in the one or more processor(s) 302, to provide outputs to one or more other display device(s).

The processing subsystem 302 can include other components not explicitly shown, including, for example, one or more parallel processor(s) coupled to the processing subsystem 302 via a bus or other communication link. The communication link may be one of any number of standards-based communication link technologies or protocols, such as, but not limited to PCI (Peripheral Component Interconnect) or TCP (Transmission Control Protocol) protocols or may be a vendor specific communications interface or communications fabric. The one or more parallel processor(s) may form a computationally focused parallel or vector processing system that can include a large number of processing cores and/or processing clusters, such as a many integrated core (MIC) processor.

Within the I/O interfaces 316, a system storage unit can connect to an I/O hub to provide a storage mechanism for the computing system 302. An I/O switch can be used to provide an interface mechanism to enable connections between the I/O hub and other components, such as a network adapter 324 and/or wireless network adapter that may be integrated into the system, and various other devices that can be added via one or more add-in device(s), such as, for example, one or more external graphics processor devices, graphics cards, and/or compute accelerators. The network adapter can be an Ethernet adapter or another wired network adapter. The wireless network adapter can include one or more of a Wi-Fi, Bluetooth, near field communication (NFC), or other network device that includes one or more wireless radios.

Other components of the computing system 302 not explicitly shown can include, for example, USB or other port connections, optical storage drives, video capture devices, and the like, which may also be connected to an I/O hub. Communication paths interconnecting the various components in FIG. 3 may be implemented using any suitable wired or wireless, local or remote computing protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) may incorporate circuitry optimized for graphics and video processing, including, for example, video output circuitry, and constitutes a graphics processing unit (GPU), a neuromorphic processing unit, and/or a central processing unit (CPU). Alternatively, or additionally, the one or more parallel processor(s) can incorporate circuitry optimized for general purpose processing, while preserving the underlying computational architecture, described in greater detail herein. Components of the computing system 302 may be integrated with one or more other system elements on a single integrated circuit. For example, one or more of parallel processor(s), memory hubs, processor(s), and I/O hubs can be integrated into a system on chip (SoC) integrated circuit. Alternatively, the components of the computing system 302 can be integrated into a single package to form a system in package (SIP) configuration. In one embodiment at least a portion of the components of the computing system 100 can be integrated into a multi-chip module (MCM), which can be interconnected with other multi-chip modules into a modular computing system.

It will be appreciated that the computing architecture 300 shown herein is illustrative and that variations and modifications are possible. The connection topology, including the number and arrangement of components, memory, the number of processor(s), and the number of parallel processor(s), may be modified as desired. For instance, system memory can be connected to the processor(s) directly rather than through a bridge, while other devices communicate with system memory via the processor(s). In other embodiments, the I/O interfaces and memory may be integrated into a single chip. It is also possible that two or more sets of processors are attached via multiple sockets, which can couple with two or more instances of the parallel processor(s).

The foregoing description of the specific embodiments describes the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Those skilled in the art will recognize that the embodiments herein can be practiced with modification within the spirit and scope of the appended claims.

What is claimed is:

1. A system comprising:
a non-transitory computer-readable medium with instructions encoded thereon; and
one or more processors configured to, when executing the instructions, perform operations of:
identifying a plurality of operational readiness data and a plurality of policy data for a workforce;
filtering the plurality of operational readiness data and the plurality of policy data to define a ready workforce;
providing a first user interface to a manager;
providing a second user interface to a worker;
detecting a selection of a date range for scheduling the ready workforce;
optionally receiving at least one priority constraint from the manager;
optionally receiving at least one scheduling preferences from a worker;
calculating, by applying an iterative computer model, a work schedule for the ready workforce during the date range; and
publishing the work schedule.

2. The system of claim 1, wherein the operational readiness data comprises, personnel duties, roles, qualifications, availability, and personal schedule preferences.

3. The system of claim 1, wherein the operational readiness data comprises current status of training and qualifications, maintenance, supply and logistics, personnel and work experience, medical readiness, travel, and availability.

4. The system of claim 1, wherein at least one of the at least one priority constraint comprises a weighting factor.

5. The system of claim 1, receiving at least one scheduling preferences from a worker, the scheduling preference being selected from the group consisting of time off requests, other duties that might interfere with scheduling, and training that might impact optimal scheduling.

6. The system of claim 1, wherein the plurality of operational readiness data include at least one hard constraint that cannot be violated in calculating the work schedule.

7. The system of claim 1, wherein the plurality of policy data include at least one hard constraint that cannot be violated in calculating the work schedule.

8. A computer program product comprising a non-transitory computer-readable storage medium containing computer program code, the computer program code when executed by one or more processors causes the one or more processors to perform operations, the computer program code comprising instructions to:
identify a plurality of operational readiness data and a plurality of policy data for a workforce;
filter the plurality of operational readiness data and the plurality of policy data to define a ready workforce;
provide a first user interface to a manager;
provide a second user interface to a worker;
detect a selection of a date range for scheduling the ready workforce;
optionally receive at least one priority constraint from the manager;
optionally receive at least one scheduling preferences from a worker;
calculate, by applying an iterative computer model, a work schedule for the ready workforce during the date range; and
publish the work schedule.

9. The computer program of claim 8, wherein the operational readiness data comprises, personnel duties, roles, qualifications, availability, and personal schedule preferences.

10. The computer program of claim 8, wherein the operational readiness data comprises current status of training and qualifications, maintenance, supply and logistics, personnel and work experience, medical readiness, travel, and availability.

11. The computer program of claim 8, wherein at least one of the at least one priority constraint comprises a weighting factor.

12. The computer program of claim 8, receiving at least one scheduling preferences from a worker, the scheduling preference being selected from the group consisting of time off requests, other duties that might interfere with scheduling, and training that might impact optimal scheduling.

13. The computer program of claim 8, wherein the plurality of operational readiness data include at least one hard constraint that cannot be violated in calculating the work schedule.

14. The computer program of claim 8, wherein the plurality of policy data include at least one hard constraint that cannot be violated in calculating the work schedule.

15. A computer implemented method, comprising:
identifying a plurality of operational readiness data and a plurality of policies data for a workforce;
filtering the plurality of operational readiness data and the plurality of policy data to define a ready workforce;
providing a first user interface to a manager;
providing a second user interface to a worker;
detecting a selection of a date range for scheduling the ready workforce;
optionally receiving at least one priority constraint from the manager;
optionally receiving at least one scheduling preferences from a worker;
calculating, by applying an iterative computer model, a work schedule for the ready workforce during the date range; and
publishing the work schedule.

16. The computer implemented method of claim 15, wherein the operational readiness data comprises, personnel duties, roles, qualifications, availability, and personal schedule preferences.

17. The computer implemented method of claim 15, wherein the operational readiness data comprises current status of training and qualifications, maintenance, supply and logistics, personnel and work experience, medical readiness, travel, and availability.

18. The computer implemented method of claim 15, wherein at least one of the at least one priority constraint comprises a weighting factor.

19. The computer implemented method of claim 15, receiving at least one scheduling preferences from a worker, the scheduling preference being selected from the group consisting of time off requests, other duties that might interfere with scheduling, and training that might impact optimal scheduling.

20. The computer implemented of claim 15, wherein the plurality of policy data include at least one hard constraint that cannot be violated in calculating the work schedule.
